(19) United States
(12) Patent Application Publication
(10) Pub. No.: US 2024/0189788 A1
(43) Pub. Date: Jun. 13, 2024

(54) MIXING APPARATUS

(71) Applicants: Javier Maldonado, Vista, CA (US); Nathan Meyer, Vista, CA (US)

(72) Inventors: Javier Maldonado, Vista, CA (US); Nathan Meyer, Vista, CA (US)

(21) Appl. No.: 18/555,420

(22) PCT Filed: Apr. 14, 2022
(86) PCT No.: PCT/US22/24776

§ 371 Date: Oct. 13, 2023

Related U.S. Application Data
(60) Provisional application No. 63/174,677, filed on Apr. 14, 2021.

(51) Int. Cl. B01F 35/33; B01F 29/10; B01F 29/34; B01F 35/30; B01F 35/32; B01F 101/14

(52) U.S. Cl. CPC B01F 35/33; B01F 29/10; B01F 29/34; B01F 35/3202; B01F 2035/352; B01F 2101/14

(57) ABSTRACT

A mixing apparatus is disclosed. The mixing apparatus includes a cradle assembly disposed within an enclosure wherein the cradle assembly is configured to receive a container for mixing. A crank is coupled to the enclosure is configured to rotate the cradle assembly by a rotational mechanism. The rotational mechanism may include a yoke coupled to a bottom portion of the cradle assemble and further coupled to the enclosure. The rotational mechanism may include a drive gear assembly for reducing force required on the crank.

### TECHNICAL FIELD

This invention relates to a mixing apparatus, and more specifically to an apparatus for mixing powder with liquid for consumption.

### BACKGROUND ART

Consuming supplements via powder continue to increase in popularity. In addition to protein powder, there exists a variety of powder supplements to satisfy customers beyond just athletes. Examples include nutritional supplement powder and dietary supplement powder. Consumption of supplements containing a powder component requires mixing with a liquid often being water. Complete mixing of the powder so that the powder fully dissolves is a desirable result and makes consumption of the drink easier and more pleasing.

There is a need for an apparatus which efficiently mixes a liquid and powder together with minimal strength required of the user.

### SUMMARY OF INVENTION

### Technical Problem

Current means of mixing includes placing both liquid and powder within a container and shaking the container vigorously. This requires a considerable amount of strength which can make proper mixing difficult based on the physical condition of the user. Other means include using a utensil to stir. However, this also includes a fair amount of strength and usually is inconsistent on thoroughly mixing the powder with the liquid.

### Solution to Problem

A mixing apparatus requiring minimal effort to thoroughly mix is disclosed. The mixing apparatus comprises an enclosure configured to receive a container such as a cup. The container nests within cradle assembly. Contents, usually an amount of liquid and an amount of powder are put into the container and the container is then installed into the cradle assembly disposed within the enclosure. The mixing apparatus further comprises a rotating assembly configured to rotate the container in such a manner where contents contained therein are sufficiently mixed together without the need of additional tools or a considerable amount of force by the user. By easily rotating a crank of the mixing apparatus at a moderate speed, the container is rotated with appropriate angular momentum and a plurality of alternating directions to overcome factors such as centrifugal force that normally prevents proper mixing due grouping of the contents.

In some embodiments, the mixing apparatus comprises a cradle assembly having a bottom portion rotatably coupled to a first end of a yoke and a removable container disposed within the cradle assembly. The yoke further comprises a second end which is rotatably coupled to the enclosure. The cradle assembly is further coupled to a flywheel via a coupling element. The mixing apparatus further comprises a crank having a crank knob and a crank handle. The crank is coupled to a first rotating shaft which is coupled to a drive gear assembly.

### Advantageous Effects of Invention

The drive gear assembly allows for a lower force required to turn the crank and rotate the cradle assembly. The flywheel allows for storage of rotational energy which can allow a user to applying force yet allow the cradle assembly to continue to mix.

The yoke coupled to the cradle assembly and enclosure provides constrained movement at the bottom portion of the cradle assembly and a less constrained movement at the top portion, mitigates clumping and ensures through mixing.

Other features and benefits will be appreciated by one having skill in the art upon a thorough review of the instant disclosure.

### BRIEF DESCRIPTION OF THE DRAWINGS

These and other features of the invention will become apparent to one having the ordinary level of skill in the art upon a thorough review of the following details and descriptions, particularly when reviewed in conjunction with the drawings, wherein:

FIG. 1 shows a perspective view of a cradle assembly according to a first illustrated embodiment;

FIG. 2 shows another perspective view of the cradle assembly according to the first illustrated embodiment;

FIG. 3 shows a perspective view of a cradle closed according to the first illustrated embodiment;

FIG. 4 shows a transparent perspective view of a mixing apparatus according to the first illustrated embodiment;

FIG. 5 shows a transparent side view of the mixing apparatus according to the first illustrated embodiment;

FIG. 6 shows a top view of the mixing apparatus according to the first illustrated embodiment;

FIG. 7 shows perspective view of the mixing apparatus according to the first illustrated embodiment;

FIG. 8 shows another perspective view of the mixing apparatus according to the first illustrated embodiment;

FIG. 9 shows a side view of a mixing apparatus according to a second illustrated embodiment;

FIG. 10 shows a front perspective view of the mixing apparatus according to the second illustrated embodiment;

FIG. 11 shows a rear perspective view of the mixing apparatus according to the second illustrated embodiment;

FIG. 12 shows a perspective view of a measuring cup apparatus according to an illustrated embodiment; and

FIG. 13 shows a front view of a cross-section of the measuring cup apparatus according to an illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, reference numbers are provided in the drawings for illustrating certain features of embodiments. Where distinct figures of the drawings utilize a shared reference number, it can be appreciated that the feature corresponding to the shared reference number is the same or similar, perhaps observed from a different view, or observed with respect to a different embodiment deploying the same or similar feature.

For purposes herein, the term “crank” means an arm secured at near a right angle to a shaft with which it can rotate. An arm attached to a rotating shaft by which circular motion is imparted to the shaft.

The term “flywheel” means a mechanical device specifically designed to use the conservation of angular momentum so as to efficiently store rotational energy.

The term “yoke” means a clamp or vise that holds a machine part in place or controls its movement or that holds two parts together.

The term “one-way bearing” means a bearing designed to transmit torque between a shaft and housing in one direction and allow free motion in the opposite direction.

The term “cradle axis” means an axis at which the cradle assembly is configured to rotate about.

The term “enclosure midline” means a midsection of the enclosure running from top of the enclosure to the bottom. Enclosure midline may transverse a center mass of the enclosure.

Unless explicitly defined herein, terms are to be construed in accordance with the plain and ordinary meaning as would be appreciated by one having skill in the art.

### General Description of Embodiments

In one embodiment, a mixing apparatus is disclosed. The mixing apparatus comprises an enclosure having an enclosure midline and a crank disposed on the enclosure midline. The crank is coupled to a first rotating shaft, and the first rotating shaft is at least partially disposed inside the enclosure. A drive gear assembly is coupled to the first rotating shaft and further coupled to a second rotating shaft, wherein the drive gear assembly comprises a first drive gear and a second drive gear. The first drive gear is coupled to the first rotating shaft and the second drive gear is coupled to the second rotating shaft. A flywheel is coupled to the second rotating shaft with a one-way bearing. The flywheel includes a flywheel center and an outer section extending radially from the flywheel center. A cradle assembly is coupled to the flywheel, and includes a bottom portion, a top portion opposite the bottom portion, and a cradle cover disposed on the top portion. The cradle assembly is configured to hold a container containing powder and liquid for mixing. A yoke having a first end is rotatably coupled to the bottom portion and a second end opposite the first end is rotatably coupled to the enclosure. The enclosure encapsulates the cradle assembly, the flywheel, the yoke, and the drive gear assembly.

In some embodiments, the first drive gear may comprise a diameter greater than the second drive gear.

In some embodiments, the flywheel center may be aligned with the enclosure midline.

In some embodiments, the cradle assembly may be coupled to the outer section of the flywheel.

In some embodiments, the enclosure may further comprise a first half and a second half wherein the first half and second half are symmetrical about the enclosure midline.

In some embodiments, the enclosure may further comprise an enclosure lid hingedly coupled therewith.

In some embodiments, the mixing apparatus may further comprise a removable container configured to nest within the cradle assembly.

In another embodiment, a mixing apparatus is disclosed. The mixing apparatus comprises an enclosure, a crank disposed on the enclosure, and a cradle assembly coupled to the crank. The cradle assembly includes a bottom portion, a top portion opposite the bottom portion. The mixing apparatus includes a yoke having a first end rotatably coupled to the bottom portion and a second end opposite the first end rotatably coupled to the enclosure.

In some embodiments the enclosure may encapsulate the cradle assembly and the yoke.

In some embodiments the enclosure may further comprise a first half and a second half surrounding an enclosure midline wherein the first half is in mirror configuration with the second half.

In some embodiments, the enclosure may further comprise an upper half and an enclosure midline wherein the crank is disposed on the upper half at the enclosure midline.

In some embodiments the enclosure may further comprise an enclosure lid hingedly coupled therewith.

In some embodiments, the mixing apparatus may further comprise a removable container configured to nest within the cradle assembly.

In another embodiment, a mixing apparatus is disclosed. The mixing apparatus comprises an enclosure, a crank disposed on the enclosure, the crank being coupled to a first rotating shaft wherein first rotating shaft is at least partially disposed inside the enclosure, a drive gear assembly coupled to the first rotating shaft and further coupled to a second rotating shaft, a flywheel coupled to the second rotating shaft wherein the flywheel has a flywheel center and an outer section extending radially from the flywheel center, and a cradle assembly coupled to the cradle and configured to hold a container. The cradle assembly having a bottom portion, and a top portion opposite the bottom portion. A yoke having a first end and a second end is rotatably coupled to the bottom portion at the first end rotatably coupled to the enclosure at the second end. The enclosure encapsulates the cradle assembly, the flywheel, the yoke, and the drive gear assembly.

In some embodiments, the drive gear assembly may further comprise a first drive gear and a second drive gear wherein the first drive gear is coupled to the first rotating shaft and the second drive gear is coupled to the second rotating shaft.

In some embodiments, the first drive gear may comprise a diameter greater than the second drive gear.

In some embodiments, the mixing apparatus may further comprise a one-wear bearing disposed between the flywheel and the second rotating shaft.

In some embodiments, the enclosure may further comprise an enclosure midline wherein the flywheel center is aligned with the enclosure midline.

In some embodiments, the cradle assembly may be coupled to the outer section of the flywheel.

In some embodiments, the enclosure may further comprise a first half and a second half surrounding an enclosure midline wherein the first half is in mirror configuration with the second half.

In some embodiments, the enclosure may further comprise an enclosure lid hingedly coupled therewith.

In some embodiments, the mixing apparatus may further comprising a removable container configured to nest within the cradle assembly.

Generally, components of the mixing apparatus are manufactured from thermoplastics, metal or a combination thereof that will be appreciated by one having skill in the art. Portions of the mixing apparatus which are exposed to the powder and/or liquid must both be safe for consumption in addition resistive to corrosion. Ease of cleaning is also a factor when considering proper material choice.

Plastic manufacturing techniques that are known to one having skill in the art can be used for construction of the mixing apparatus. Injection molding is one plastic manufacturing technique that is preferable to making relatively small objects with a high degree of accuracy.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

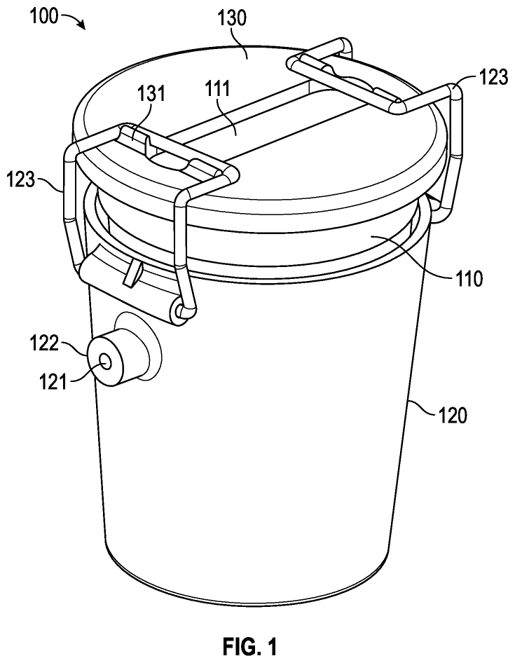

Now turning to the drawings, FIG. 1 shows a perspective view of a cradle assembly (100) according to a first illustrated embodiment. The cradle assembly comprises a container (110) nested within a cradle (120). The container has a container lid (111) covering an opened portion of the container. Coupled to the container lid is a cradle cover (130) via one or more fasteners (123). The fasteners are rotatably coupled to the cradle and configured to couple to one or more fastener catches (131) disposed on the cradle cover. The cradle further comprises an attachment element (122) disposed at a cradle axis (121). The attachment element is configured to couple to a mixing apparatus (not shown). The container is configured to hold contents such as liquid and/or powder. When rotated in a sufficient manner and quantity, the contents within the container will sufficiently combine therein.

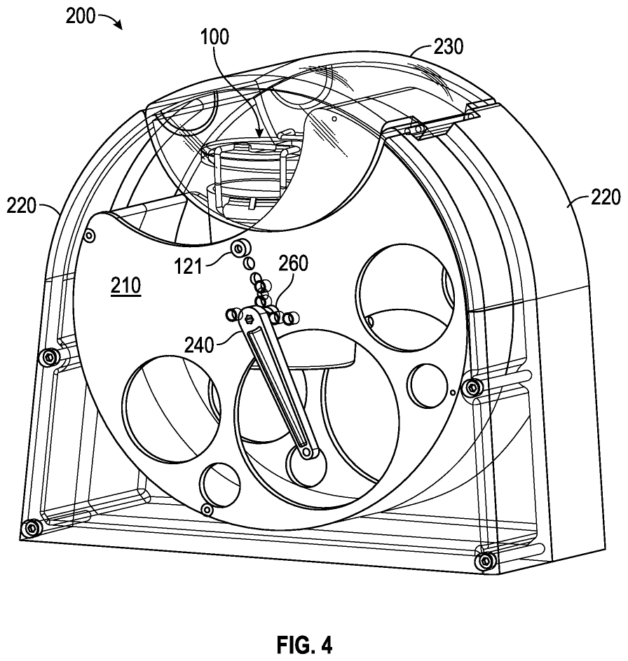

Generally, the cradle axis (121) is disposed at an upper portion of the cradle (120) such that a predominate weight within a container is below the cradle axis. The higher the cradle axis is disposed on the cradle, the greater a rotational force the cradle assembly (100) will experience when coupled to a mixing apparatus (FIG. 4, 200).

In some embodiments, the container lid (111) has a sealing element to prevent contents within the container (100) from spilling. In other embodiments, the cradle cover (130) is capable of performing functions of the container lid and coupling directly to the container (111).

Although the fastener (123) is shown as being a latch, other means of fastening the cradle cover (130) to the cradle (120) may also be implemented by one having skill in the art. For example, and without limitation, an alternative fastener may include the cradle and/or cradle cover comprising threaded portions such that the cradle and cradle cover are configured to screw together.

In some embodiments, the cradle (120) is configured to hold a container (110) having a container height and container radius. In other embodiments, the cradle is configured to hold containers of various sizes having a plurality of container heights and/or container radii.

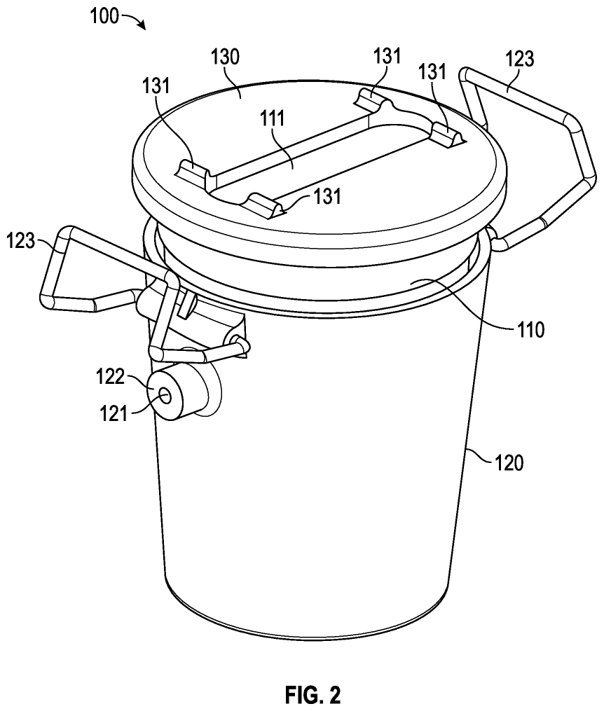

FIG. 2 shows another perspective view of the cradle assembly (100) according to the first illustrated embodiment. The cradle assembly comprises a cradle (120) encapsulating a container (110). A container lid (111) covers the container and disposed on top of the container lid is a cradle cover (130). The cradle assembly is configured to couple the cradle cover to the container lid by one or more fasteners (123). The fasteners are coupled to the cradle and configured to engage with at least one fastener catch (131), thereby restraining the cradle cover and container lid from moving. The cradle includes a cradle axis (121) disposed below the fastener. An attachment element (122) is disposed at the cradle axis. In some embodiments, the cradle comprises two attachment elements disposed on opposite sides of the cradle.

In an alternative embodiment, the fastener (123) is coupled the cradle cover (130) and the fastener catch (131) is disposed on the cradle (120). The fastener is configured to engage with the fastener catch.

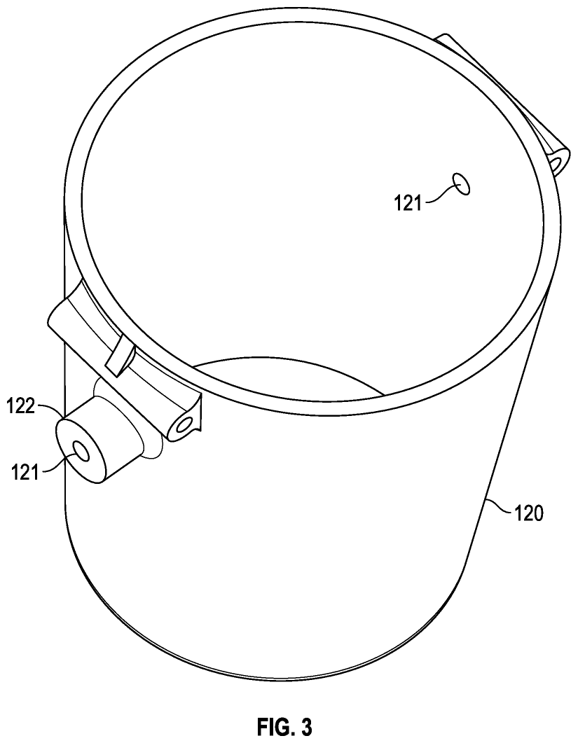

FIG. 3 shows a perspective view of a cradle (120) closed according to the first illustrated embodiment. The cradle is configured to contain a container (not shown). The cradle includes a cradle axis (121) that extends through the cradle. Disposed on the cradle at the cradle axis is an attachment element (122), the attachment element is configured to couple to a mixing apparatus (FIG. 4, 200). The cradle is further configured to couple with one or more fasteners (not shown). In some embodiments, the container inserted within the cradle could be characterized as having snug fit to prevent the container from moving. In other embodiments, the cradle is configured to restrain the container from movement as appreciated by one having skill in the art. The attachment element (122) may be a stem projected outwards from the cradle (120) and configured to couple to a rotational apparatus (not shown). The attachment element may also comprise a latch, hook or any other structures for attachment that is known by one having skill in the art.

### Second Illustrated Embodiment

FIG. 4 shows a translucent perspective view of a mixing apparatus (200) according to the first illustrated embodiment. The mixing apparatus comprises a cradle assembly (100) having a cradle axis (121). The cradle assembly is coupled to a rotational apparatus (210) via one or more attachment elements (121), wherein the cradle assembly is capable of rotating about the cradle axis. The rotational apparatus is coupled to an enclosure (220) at a rotational axis (260) by a shaft. The rotational apparatus is configured to couple to the enclosure and freely rotate therein. A rotational mechanism (240) is coupled to the shaft. The rotational mechanism can be a hand crank, electric motor, or other rotational mechanism known to on having skill in the art. The enclosure includes an enclosure lid (230) which is configured to open and close and allow installation of the cradle assembly. Between the rotational axis and the cradle axis is a distance such that when the rotational apparatus rotates, the cradle assembly is capable of rotating relative to the rotational axis and cradle axis. This allows the cradle assembly to move in various directions thereby efficiently mixing any contents disposed therein.

In an alternative embodiment, the mixing apparatus (200) is configured to hold a plurality of cradle assemblies (120).

In some embodiments, a container (FIG. 1 110) of the cradle assembly (100) is configured to couple directly to the rotational apparatus (210) such that a cradle (FIG. 1 120) is no longer required. The container comprises attachment elements or other means to easily engage and disengage the container from the rotational apparatus.

In some embodiments, the container (110) is installed into the cradle (120) outside of the rotational apparatus (210), thereby forming the cradle assembly (100). The cradle assembly is then coupled to the rotational apparatus. When mixing is complete, the cradle assembly is subsequently decoupled from the rotational apparatus and removed from the enclosure (220). The container is then removed from the cradle.

In other embodiments the container (110) is installed and removed from the cradle (120) while the cradle is coupled to the rotational apparatus (210). When mixing is complete, the container is pulled out of the enclosure (220).

In some embodiments, a locking mechanism is included with the mixing apparatus (200) to maintain the cradle (120) in an upright position while the cradle is coupled to the rotational apparatus (210). This will allow for easier installation and removal of the container (110) from the enclosure (220). In one embodiment, the locking mechanism is a manually-actuated button to engage and disengage the locking mechanism. In another embodiment, the locking mechanism engages when a button is manually pressed and disengages when the cradle assembly (100) has made one full rotation around the rotational axis (260). In another embodiment, the locking mechanism engages while the enclosure lid (230) is open and disengages when the enclosure lid is closed. Other ways to achieve an appropriate locking mechanism will be appreciated by one having skill in the art.

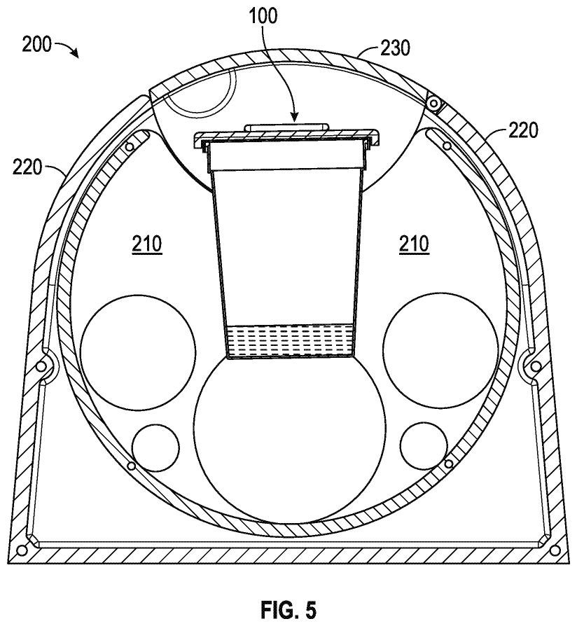

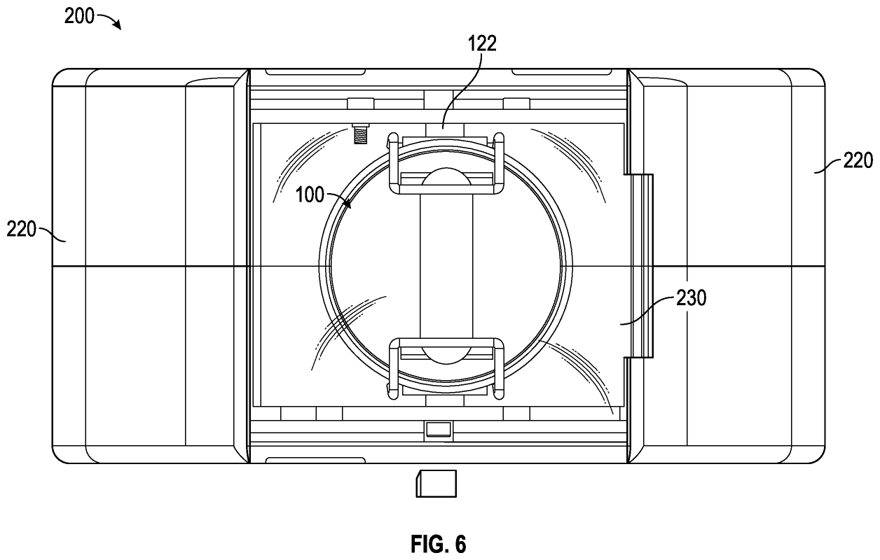

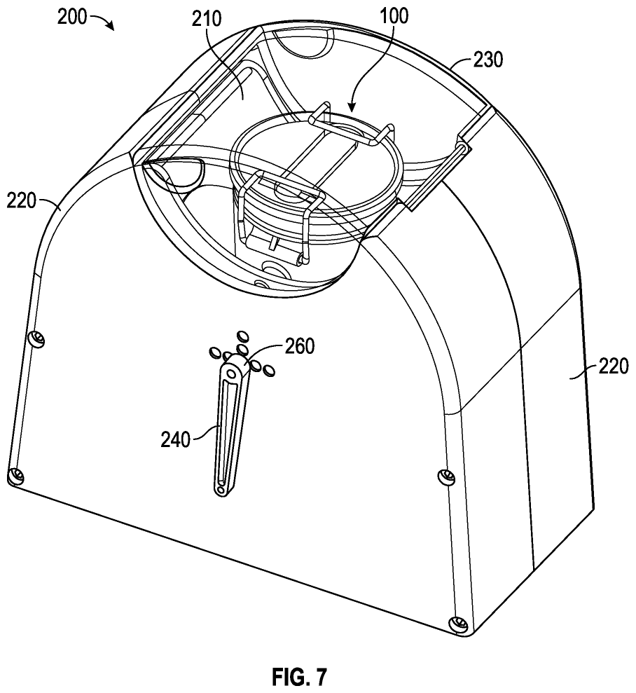

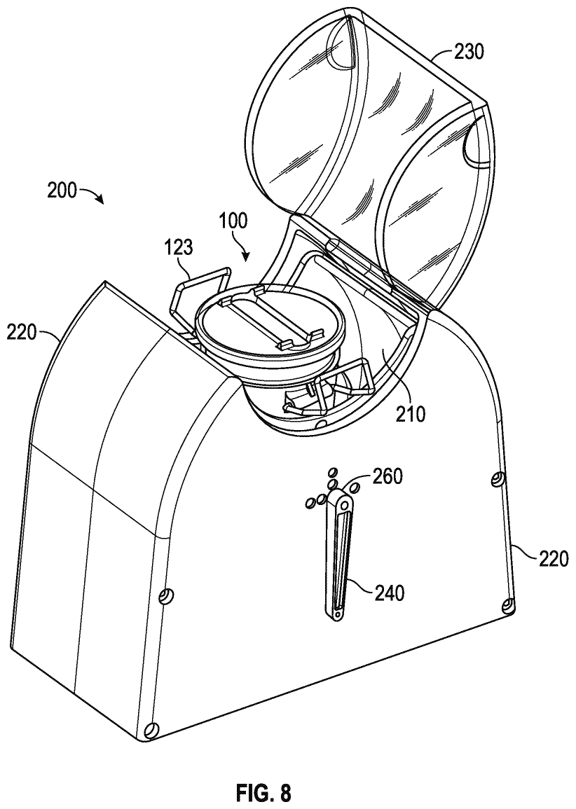

FIG. 5-8 shows various views and of the mixing apparatus (200) according to the second illustrated embodiment.

### Third Illustrated Embodiment

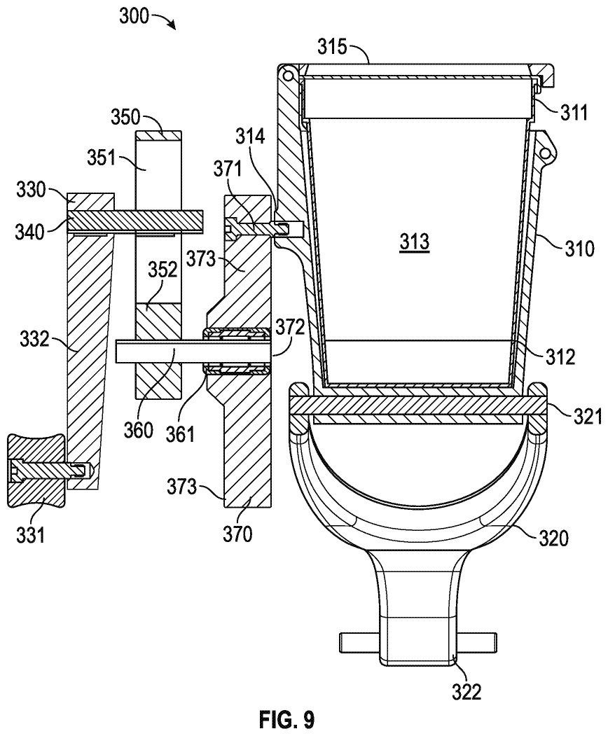

FIG. 9 shows a side view of a mixing apparatus (300) according to a second illustrated embodiment. The mixing apparatus comprises a container (313) disposed within a cradle assembly (310) having a top portion (311) and a bottom portion (312), wherein the bottom portion is rotatably coupled to a first end (321) of a yoke (320). A cradle cover (315) is disposed at the top portion hingedly coupled to the cradle assembly for covering the container disposed therein. Other means of attachment the cradle cover to the cradle assembly may include sliding, detaching, and rotating. The yoke further comprises a second end (322) which is coupled to an enclosure (not shown). The cradle assembly is additionally coupled to a flywheel (370) at a cradle axis (314) via a coupling element (371). The mixing apparatus further comprises a crank (330) having a crank knob (331) and a crank handle (332). The crank is coupled to a first rotating shaft (340) which is coupled to a drive gear assembly (350). As shown the drive gear assembly comprises a first drive gear (351) and a second drive gear (352). The second drive gear is coupled to a second rotating shaft (360) which is further coupled to the flywheel as described above.

The crank (330) can be turned by the crank knob (331) and crank handle (332). Rotational motion is translated to the first rotating shaft (340) which rotates the first gear (351) of the drive gear assembly (350). The first gear is configured to rotate the second drive gear (352) which causes the second rotating shaft (360) to rotate as well. Rotation of the second rotating shaft then causes the flywheel (370) to rotate which translates to the cradle assembly (310) and container (313) to also move in directions that allows for efficient mixing of contents contained with the container. In other embodiments, a motor is used in addition or in place of the crank, such as a belt drive motor.

The yoke (320) aids in the mixing by causing the container (313) to spin in alternating directions. Partially limiting motion of the bottom portion (312) of the cradle assembly (310) while a top portion (311) can move more freely prevents the container from staying in a same position for a long period of time. A combination of the top portion movement and the bottom portion constrained in motion allows for more efficient mixing and deters the powder form gathering at the bottom portion due to centrifugal force. The second end (322) of the yoke is rotatably coupled to a portion of an enclosure or a stationary portion associated therewith, for example a base. The yoke is configured to pivot about a coupling of the second end and capable of producing an angle up to a particular amount, depending on factors including length of the yoke, length of the cradle assembly, and location of the cradle assembly attached to the flywheel (370). In one embodiment, the angle is limited to up to 40 degrees due to the presence of a 3-way linkage. The yoke coupled to the cradle assembly simulates a user arm wherein the yoke is analogous to an elbow of an arm.

The flywheel (370) and the second rotating shaft (360) coupling includes a one-way bearing (361) which transmits torque in one direction and allows free motion in the opposite direction. The flywheel uses conservation of angular momentum to efficiently store rotational energy such that after a user has initiated the crank (330) and the mixing apparatus (300) has reached a sufficient amount of angular momentum, the crank can cease turning (or force applied to crank is reduced) and the apparatus will continue to rotate and mix contents within the container due to storage of the rotational energy contained within the flywheel. The flywheel comprises a flywheel center (372) and an outer section (373) extending radially from the flywheel center. The second rotating and the one-way bearing are disposed on the flywheel at the flywheel center. The cradle assembly (310) is coupled to the flywheel at the outer section. This causes the cradle assembly to experience a rotational force with the cradle assembly being coupled away from the flywheel center. A greater a distance between the flywheel center and the outer section where the cradle assembly is coupled thereto, an increase in rotational force will be experience by the cradle assembly and subsequently the container (313) nested therein.

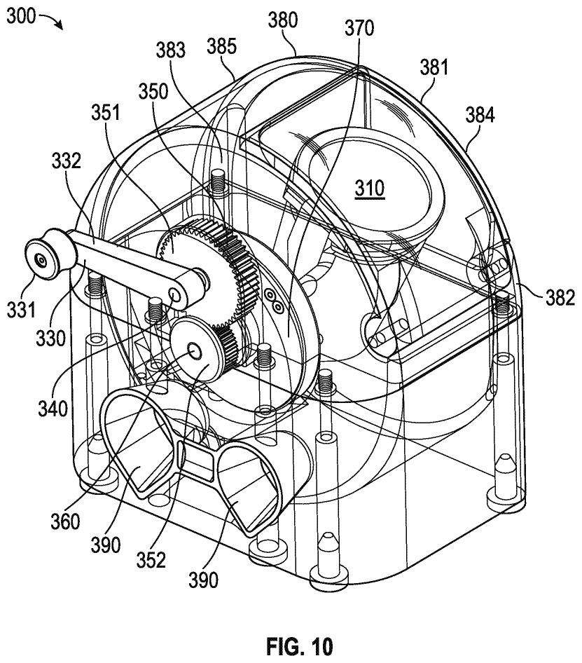

FIG. 10 shows a front perspective view of the mixing apparatus (300) according to the second illustrated embodiment. The mixing apparatus comprises a crank (330) coupled to a drive gear assembly (350) via a first rotating shaft (340). The drive gear assembly is further coupled to a flywheel (370) via a second rotating shaft (360). The flywheel is coupled to a cradle assembly (310) and a removable container disposed within the cradle assembly for mixing contents stored therein. The mixing apparatus further comprises an enclosure (380) which encapsulates the cradle assembly and container during mixing in addition to encapsulating the flywheel and drive gear assembly. An enclosure (380) is disposed at an upper half (382) of the enclosure and is hingedly coupled for providing access to the removable container. Only the crank, which comprises a crank knob (331) and crank handle (332) are exterior to the enclosure. The enclosure includes a lid for inserting and retrieving the container from the mixing apparatus. A measuring cup apparatus (390) is coupled to the enclosure as shown. In some embodiments, the lid includes a magnet which allows the lid to magnetically to couple to the enclosure during operation.

The drive gear assembly (350), as shown, comprises a first drive gear (351) and a second drive gear (352). As shown, the first drive gear comprises a larger diameter compared to the second drive gear, thereby decreasing torque and increasing angular momentum, which is preferable when rotating a lightweight object at a desirable higher speed. With the drive gear assembly as shown, a user is able to rotate the crank (330) at a moderate speed and still achieve a high number of rotations of the cradle assembly (310). In other embodiments, alternate configurations of the drive gear assembly may be utilized including number and size of gears to achieve similar results. Similar use of a drive gear assembly may be utilized in conjunction with a motorized system.

The enclosure (380) further comprises an enclosure midline (383) and a first half (384) and a second half (385) disposed on either side of the enclosure midline. In some embodiments, the first half and second half are in mirror configuration of one another and are symmetrical about the enclosure midline. In some embodiments, the crank (330) is coupled to the enclosure midline to improve stability of the mixing apparatus (300) as the cradle assembly (310) rotates about an interior of the enclosure. In some embodiments, a flywheel center (372, FIG. 9) of the flywheel (370) is aligned with the enclosure midline to improve stability of the mixing apparatus during rotation.

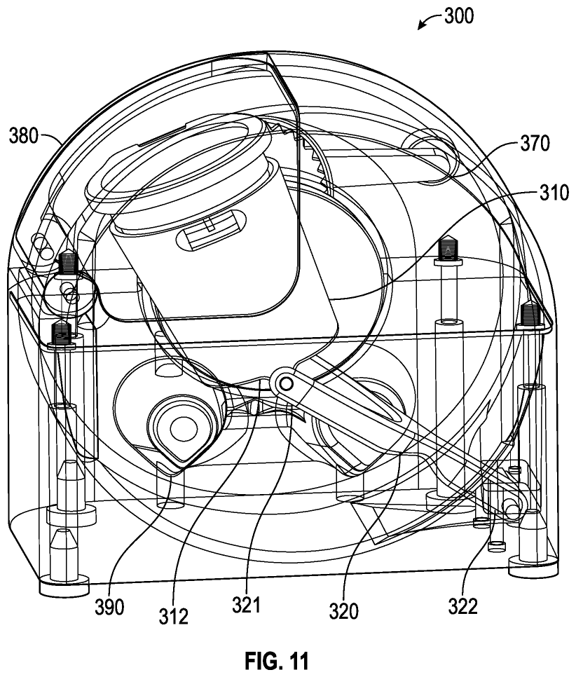

FIG. 11 shows a rear perspective view of the mixing apparatus (300) according to the second illustrated embodiment. The mixing apparatus includes a cradle assembly (310) coupled to a yoke (320). A first end (321) of the yoke is rotatably coupled to a bottom portion (312) of the cradle assembly. The yoke also comprises a second end (322) which is rotatably coupled to portion of an enclosure (380), such as a base.

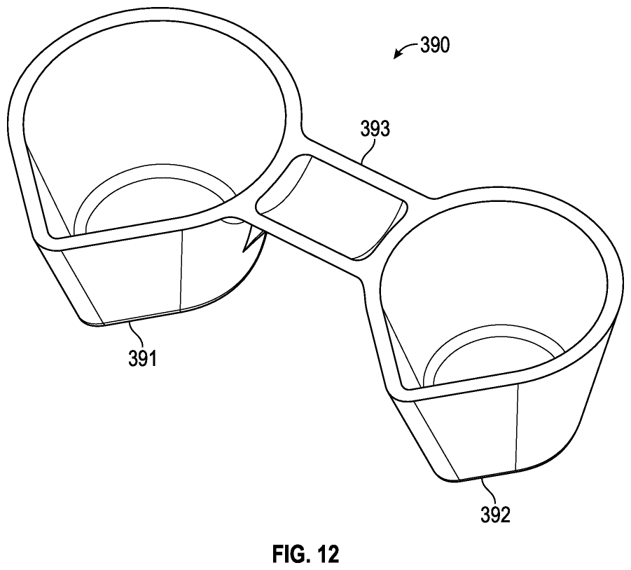

FIG. 12 shows a perspective view of a measuring cup apparatus (390) according to an illustrated embodiment. The measuring cup apparatus comprises a first measuring (391) coupled to a second measuring cup (392) via a connection element (393). In a preferred embodiment, the first and second measuring cups comprise different volumes. For example, the first measuring cup may comprise 2 oz. and the second measuring cup may comprise 1 oz, thereby allowing a user to measure a plurality of powder measurements.

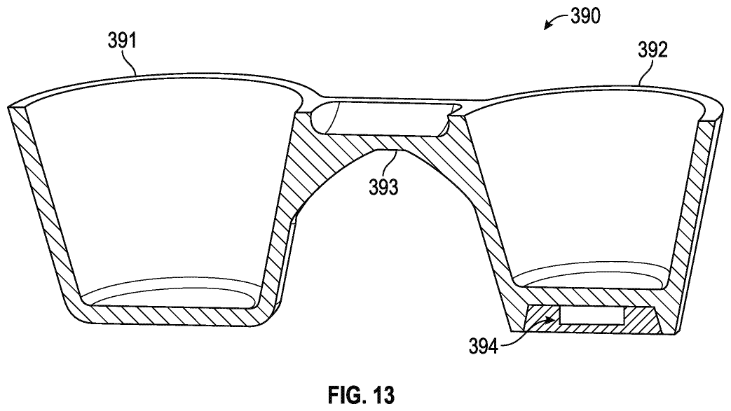

FIG. 13 shows a front view of a cross-section of the measuring cup apparatus (390) according to an illustrated embodiment. The measuring cup apparatus includes a first measuring cup (391) and a second measuring cup (392) coupled together via a connection element (393). The measuring cup apparatus further comprises a magnet (394) disposed at a bottom portion and configured to couple to an enclosure (FIG. 10, 380) when not in use. In other embodiments, the measuring cup apparatus comprises a ferrous metal and the enclosure comprises the magnet for coupling.

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### FEATURE LIST

cradle assembly (100; 310)
container (110; 313)
container lid (111)
cradle (120)
cradle axis (121; 314)
attachment element (122)
fastener (123)
cradle cover (130; 315)
fastener catch (131)
mixing apparatus (200; 300)
rotational apparatus (210)
enclosure (220; 380)
enclosure lid (230; 381)
rotational mechanism (240)
shaft (250)
rotational axis (260)
top portion (311)
bottom portion (312)
yoke (320)
first end (321)
second end (322)
crank (330)
crank knob (331)
crank handle (332)
first rotating shaft (340)
drive gear assembly (350)
first drive gear (351)
second drive gear (352)
second rotating shaft (360)
one-way bearing (361)
flywheel (370)
coupling element (371)
flywheel center (372)
outer section (373)
upper half (382)
enclosure midline (383)
first half (384)
second half (385)
measuring cup apparatus (390)
first measuring cup (391)
second measuring cup (392)
connection element (393)
magnet (394)

What is claimed is:

1. A mixing apparatus, comprising:
an enclosure having an enclosure midline;
a crank disposed on the enclosure midline,
the crank coupled to a first rotating shaft, the first rotating shaft at least partially disposed inside the enclosure;
a drive gear assembly coupled to the first rotating shaft and further coupled to a second rotating shaft,
the drive gear assembly comprising a first drive gear and a second drive gear wherein the first drive gear is coupled to the first rotating shaft and the second drive gear is coupled to the second rotating shaft;
a flywheel coupled to the second rotating shaft with a one-way bearing,
the flywheel having a flywheel center and an outer section extending radially from the flywheel center;
a cradle assembly coupled to the flywheel, the cradle assembly having a bottom portion, a top portion opposite the bottom portion, and a cradle cover disposed on the top portion wherein the cradle assembly is configured to hold a container; and
a yoke having a first end rotatably coupled to the bottom portion and a second end opposite the first end rotatably coupled to the enclosure;
wherein the enclosure encapsulates the cradle assembly, the flywheel, the yoke, and the drive gear assembly.

2. The mixing apparatus of claim 1, wherein the first drive gear comprises a diameter greater than the second drive gear.

3. The mixing apparatus of claim 1, wherein the flywheel center is aligned with the enclosure midline.

4. The mixing apparatus of claim 1, wherein the cradle assembly is coupled to the outer section of the flywheel.

5. The mixing apparatus of claim 1, the enclosure further comprising a first half and a second half wherein the first half and second half are symmetrical about the enclosure midline.

6. The mixing apparatus of claim 1, the enclosure further comprising an enclosure lid hingedly coupled therewith.

7. The mixing apparatus of claim 1, further comprising a removable container configured to nest within the cradle assembly.

8. A mixing apparatus, comprising:
an enclosure;
a crank disposed on the enclosure;
a cradle assembly coupled to the crank,
the cradle assembly having a bottom portion, a top portion opposite the bottom portion; and
a yoke having a first end rotatably coupled to the bottom portion and a second end opposite the first end rotatably coupled to the enclosure.

9. The mixing apparatus of claim 8, wherein the enclosure encapsulates the cradle assembly and the yoke.

10. The mixing apparatus of claim 8, the enclosure further comprising a first half and a second half surrounding an enclosure midline wherein the first half is in mirror configuration with the second half.

11. The mixing apparatus of claim 8, the enclosure further comprising an upper half and an enclosure midline wherein the crank is disposed on the upper half at the enclosure midline.

12. The mixing apparatus of claim 8, the enclosure further comprising an enclosure lid hingedly coupled therewith.

13. The mixing apparatus of claim 8, further comprising a removable container configured to nest within the cradle assembly.

14. A mixing apparatus, comprising:
an enclosure;
a crank disposed on the enclosure,
the crank coupled to a first rotating shaft, the first rotating shaft at least partially disposed inside the enclosure;
a drive gear assembly coupled to the first rotating shaft and further coupled to a second rotating shaft;
a flywheel coupled to the second rotating shaft,
the flywheel having a flywheel center and an outer section extending radially from the flywheel center;
a cradle assembly coupled to the cradle and configured to hold a container,
the cradle assembly having a bottom portion, a top portion opposite the bottom portion; and
a yoke having a first end rotatably coupled to the bottom portion and a second end opposite the first end rotatably coupled to the enclosure;
wherein the enclosure encapsulates the cradle assembly, the flywheel, the yoke, and the drive gear assembly.

15. The mixing apparatus of claim 14, the drive gear assembly further comprising a first drive gear and a second drive gear wherein the first drive gear is coupled to the first rotating shaft and the second drive gear is coupled to the second rotating shaft.

16. The mixing apparatus of claim 15, wherein the first drive gear comprises a diameter greater than the second drive gear.

17. The mixing apparatus of claim 14, further comprising a one-wear bearing disposed between the flywheel and the second rotating shaft.

18. The mixing apparatus of claim 14, the enclosure further comprising an enclosure midline wherein the flywheel center is aligned with the enclosure midline.

19. The mixing apparatus of claim 14, wherein the cradle assembly is coupled to the outer section of the flywheel.

20. The mixing apparatus of claim 14, the enclosure further comprising a first half and a second half surrounding an enclosure midline wherein the first half is in mirror configuration with the second half.

21. (canceled)

22. (canceled)
